(19) United States
(12) Patent Application Publication
(10) Pub. No.: US 2005/0031121 A1
(43) Pub. Date: Feb. 10, 2005

(54) Encryption method and apparatus

(76) Inventor: Sung-woo Lee, Seoul (KR)

Correspondence Address: VOLENTINE FRANCOS, P.L.L.C., Suite 150, 12200 Sunrise Valley Drive, Reston, VA, 20191, US

(21) Appl. No.: 10/875,719

(22) Filed: Jun. 25, 2004

(30) Foreign Application Priority Data
Aug. 8, 2003 (KR) 2003-55031

(51) Int. Cl. H04K 1/06

(52) U.S. Cl. 380/28

(57) ABSTRACT

An encryption method and apparatus for implementing an overlapping operation, a variable clock operation, and a combination of the two operations. In the encryption method based on an overlapping operation technique, first, first through N-th fault sources effect first through N-th rounds of a first hardware engine to output a first cipher text. Thereafter, the second through (N+1)th fault sources effect first through N-th rounds of a second hardware engine, respectively, to output a second cipher text. The first and second cipher texts are compared to each other, and if the first and second cipher texts are identical, the first or second cipher text is output. The first and second hardware engines operate according to a data encryption standard (DES) algorithm. As described above, if the first and second cipher texts are identical, the first or second cipher text is output. Thus, a highly stable encryption algorithm is provided.

### BACKGROUND OF THE INVENTION

1. Field of the Invention

Embodiments of the present invention relate to an encryption method implemented by overlapping or using a variable clock. This application claims the priority of Korean Patent Application No. 2003-55031, filed on Aug. 8, 2003, in the Korean Intellectual Property Office, the disclosure of which is incorporated herein in its entirety by reference.

2. Description of the Related Art

The Data Encryption Standard (DES) algorithm is used as an encryption method and is important in communication networking. For example, the DES algorithm is used in security Internet applications, remote access servers, cable modems, and satellite modems. The DES algorithm inputs a 64-bit block and outputs a 64-bit block. 56 bits among the 64 bits are used for encryption and decryption. The remaining 8 bits are used for parity checking. A DES system is an encryption apparatus which receives a 64-bit plain text block and a 56-bit key and outputs a 64-bit cipher text.

Examples of techniques implementing the DES algorithm include permutation (e.g. P-Box), substitution (e.g. S-Box), and key scheduling for generating subkeys. During data encryption, 16 rounds of repetitive operations are performed. An input portion performs initial permutation (IP) and an output portion performs inverse IP.

FIG. 1 is a block diagram of an encryption apparatus, which implements a DES algorithm. First, the initial permutation (IP) portion 110 permutates a 64-bit plain text block. Next, the transformation portion 120 divides the 64-bit plain text block into two 32-bit blocks. One of the 32-bit blocks is stored in the left variable (L₀) register, while the other 32-bit block is stored in the right variable (R₀) register. 16 rounds of a product transformation using a cipher functions (f) and 16 rounds of a block transformation are then performed. The block transformation is executed by crossing left and right variables Lᵢ and Rᵢ (where i is an integer ranging from 1 to 16) with each other. The inverse initial permutation (IP−1) portion 130 encrypts the result of the above transformations using inverse initial permutation and outputs the cipher text.

Product transformations are achieved by the cipher function (f) 121 and the exclusive OR (XOR) portion 122. The cipher function (f) 121 receives the 32-bit block data of the right variable Rᵢ from an Rᵢ register together with the subkey Kᵢ and performs an encryption algorithm. The subkey Kᵢ is produced by a key scheduler. The XOR portion 122 performs an XOR operation on the result of the cipher function (f) 121 and the output of an Lᵢ register. The XOR outputs the result of the XOR operation to the right variable register, next to the Rᵢ register. Specifically, the 32-bit block data obtained by the XOR portion 122 is transferred to and stored in a right variable (Rᵢ₊₁) register. The 32-bit data stored in the Ri register is transferred to and stored in a left variable (L₁₊₁) register. This algorithm corresponds to one round and 16 rounds are performed in the DES algorithm.

When a 64-bit plain text block is processed by the IP portion 110, it is divided into two blocks. These two blocks are stored in the L₀ and R₀ registers, each of the 16 rounds are expressed in Equations 1 and 2:
L=Rᵢ₋₁, i=1, 2, . . . , 16 (1)
Rᵢ=Lᵢ₋₁⊕f(Rᵢ₋₁,Ki), i=1, 2, . . . 16 (2)

FIG. 2 illustrates a key scheduler that generates a subkey Kᵢ (where i is an integer ranging from 1 to 16). The key scheduler includes the first permutation choice (PC) portion 200, the basic operation portion 210, and the second PC portions 220. The first PC portion 200 receives and permutates a 56-bit key. The basic operation portion 210 divides a 56-bit key block, permutated by the first PC 200 into two 28-bit blocks. The basic operation portion store the first 28-bit block in a variable (C₀) register and stores the second 28-bit block in a variable (D₀) register. The basic operation portion 210 produces 48-bit subkeys that are required by a cipher function operation during the 16 rounds of the product transformation. To achieve this subkey production, left shifters 213 and 214 of the basic operation portion 210 left-shift a left variable (Cᵢ) of a Cᵢ register 211 and a right variable (Dᵢ) of a D₁ register 212, respectively, by one or two places. The left shifters 213 and 214 store the left-shifted left and right variables Cᵢ and Dᵢ in a left variable (Cᵢ+1) register and a right variable (Dᵢ+1) register, respectively. The second PC portions 220 receive 28-bit blocks of the left and right variables Cᵢ and Dᵢ, left-shifted in each round. The second PC portions 220 outputs 48-bit subkeys Kᵢ. During 16 rounds, the left and right variables Cᵢ and Dᵢ are shifted by 28 places. Accordingly, the left variable C₁₆ is the same as the left variable C₀ and the right variable D₁₆ is the same as the right variable D₀.

FIG. 3 is a block diagram of a general DES core architecture. Referring to FIG. 3, the cipher function (f) includes the expansion permutation portion 300, the XOR portion 310, the S-Box permutation portion 320, and the P-Box permutation portion 330. The expansion permutation portion 300 copies some of the 32 bits of the right variable Rᵢ₋₁ received from an Rᵢ₋₁ register to permutate the 32-bit right variable Rᵢ₋₁ to provide a 48-bit right variable. The XOR portion 310 performs an XOR operation on the result of the permutation by the expansion permutation portion 300 and a 48-bit subkey produced during each round by a key scheduler. The S-Box permutation portion 320 substitutes a 32-bit block for a 48-bit block obtained by the XOR portion 310. The P-Box permutation portion 330 permutates the 32-bit block obtained by the S-Box permutation portion 320 and provides a permutated 32-bit block. The 32-bit block output from the P-Box permutation portion 330 is XOR-operated with a 32-bit left variable Lᵢ₋₁, stored in an Lᵢ₋₁ register. The result of the XOR operation is stored as a right variable Rᵢ in an Rᵢ register. A 32-bit right variable Rᵢ₋₁ stored in the Rᵢ₋₁ register is transferred to and stored in an Lᵢ register.

A differential cryptanalysis and a linear cryptanalysis are widely used as algorithms for attacking the DES encryption algorithm. Because these encryption attack algorithms are based on the vulnerableness of the DES algorithm, they are not suitable for actual attacks on encryption. Fault attacks have recently emerged as effective methods of attacking a public key encryption algorithm, such as, an RSA encryption algorithm. Eli Biham, who has devised the differential cryptanalysis, has proposed a differential fault attack (DFA) in which the fault attack is applied to a block encryption technique, such as the DES algorithm. The fault attack enables a key to be detected using several hundreds of pairs of a plain text, which is much less than that in related art attack methods. Hence, the fault attack is more powerful than other theoretical attack methods. Thus, an encryption apparatus and method resistible against the DFA is required.

### SUMMARY OF THE INVENTION

Aspects of embodiments of the present invention provide an encryption method for implementing an overlapping operation, in order to prevent a key value from leaking due to artificial and natural faults. Aspects of embodiments of the present invention provide an encryption method for implementing variable clock operation. Aspects of embodiments of the present invention provide an encryption method for implementing both an overlapping operation and/or a variable clock operation.

According to embodiments of the present invention, an encryption method implementing an overlapping operation is utilized. This encryption method may includes the following. Sequentially providing first through N-th fault sources to first through N-th rounds of a first hardware engine, respectively, to output a first cipher text. Sequentially providing the second through (N+1)th fault sources to first through N-th rounds of a second hardware engine, respectively, to output a second cipher text. Comparing the first and second cipher texts and outputting the first (or second) cipher text if the first and second cipher texts are identical.

In embodiments, each of the N rounds of each of the first and second hardware engines may include the following. Dividing a plain text block into two sub-blocks and storing one sub-block in a left register and the other in a right register. Executing an encryption operation by performing a cipher function with respect to data stored in the right register and a subkey. Performing an exclusive OR operation on the result of the cipher function and the output of the left register. Storing the result of the exclusive OR operation in a right register in the next round. Transferring data stored in the right register to a left register in the next round. This round repeats N times. Accordingly, each of the first and second hardware engines performs first through N-th rounds of an encryption operation.

According to embodiments of the invention, the first and second hardware engines operate according to a block encryption algorithm that can distinguish rounds (e.g. a data encryption standard (DES) algorithm). The first through (N+1)th fault sources may be environmental changes (e.g. temperature shock, barometric shock, radio frequency (RF) energy, heavy ion bombardment, ultraviolet, and laser energy). Such environmental changes attack the first and second hardware engines so that different faults are generated in their corresponding operation rounds. Accordingly, the first and second hardware engines obtain different operation results to prevent the use of a faulty cipher text. According to embodiments of the invention, the encryption method for implementing an overlapping operation further include preventing output of cipher texts if the first and second cipher texts are different. The plain text is composed of 64 bits and the 64-bit plain text is divided into two 32-bit sub-blocks.

According to embodiments of the invention, there is provided an encryption method for implementing a variable clock operation. The method may include the following. Sequentially providing first through N-th fault sources to first through N-th rounds of a first hardware engine, respectively, in response to a first clock signal to output a first cipher text. Sequentially providing the first through N-th fault sources to first through N-th rounds of a second hardware engine, respectively, in response to a second clock signal to output a second cipher text. Comparing the first and second cipher texts and outputting the first (or second) cipher text if the first and second cipher texts are identical.

Each of the N rounds of each of the first and second hardware engines may include the following. Dividing a plain text block into two sub-blocks and storing one sub-block in a left register and the other in a right register. Executing an encryption operation by performing a cipher function with respect to data stored in the right register and a subkey. Performing an exclusive OR operation on the result of the cipher function and the output of the left register, storing the result of the exclusive OR operation in a right register in the next round, and transferring data stored in the right register to a left register in the next round. This round repeats N times. Accordingly, each of the first and second hardware engines performs first through N-th rounds of an encryption operation.

According to embodiments of the invention, in an encryption method implementing a variable clock operation, the encryption operations of the first and second hardware engines may be set to start at different points of time, similar to the encryption method implementing overlapping operations. When implementing a variable clock operation, the operating clocks speeds of the first and second hardware engines are different. Accordingly, when an attacker applies a fault source to the first and second hardware engines, a corresponding fault is generated at different operation points of time of the first and second hardware engines, so that they obtain different operation results. Implementing a variable clock operation may include preventing output of cipher texts if the first and second cipher texts do not match. The plain text may be composed of 64 bits and the 64-bit plain text may be divided into two 32-bit sub-blocks.

According to embodiments of the invention, an encryption method implements both an overlapping operation and a variable clock operation. This method may include the following. Sequentially providing first through N-th fault sources to first through N-th rounds of a first hardware engine, respectively, in response to a first clock signal to output a first cipher text. Sequentially providing the second through (N+1)th fault sources to first through N-th rounds of a second hardware engine, respectively, in response to a second clock signal to output a second cipher text. Comparing the first and second cipher texts and outputting the first (or second) cipher text if the first and second cipher texts are identical.

Each of the N rounds of each of the first and second hardware engines may include the following. Dividing a plain text block into two sub-blocks and storing one sub-block in a left register and the other in a right register. Executing an encryption operation by performing a cipher function with respect to data stored in the right register and a subkey. Performing an exclusive OR operation on the result of the cipher function and the output of the left register. Storing the result of the exclusive OR operation in a right register in the next round. Transferring data stored in the right register to a left register in the next round. This round repeats N times and each of the first and second hardware engines may perform first through N-th rounds of encryption operations.

In an encryption method according to embodiments of the present invention, different fault sources are provided to corresponding rounds of operations of first and second hardware engines and they operate with different clock frequency. Consequently, first and second cipher texts are likely to be different. In spite of this circumstance, if the first and second cipher texts are identical, the first or second cipher text is output, thus providing a highly stable encryption algorithm.

### BRIEF DESCRIPTION OF THE DRAWINGS

FIG. 1 is a block diagram of an encryption apparatus implementing a DES algorithm.

FIG. 2 is a block diagram of a key scheduler that generates the subkey Kᵢ of FIG. 1.

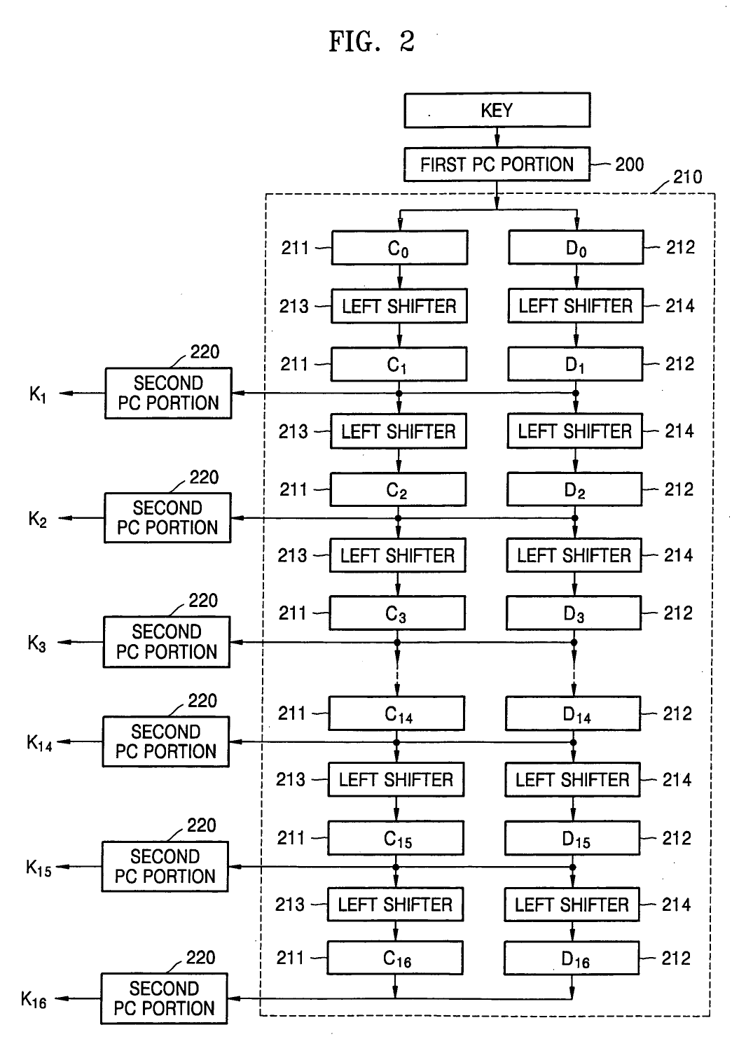

FIG. 3 is a block diagram of DES core architecture.

FIG. 4 illustrates an exemplary cryptographic engine implementing an overlapping operation.

FIG. 5 illustrates an exemplary cryptographic engine implementing a variable clock operation.

### DETAILED DESCRIPTION OF THE INVENTION

The present invention is described with reference to the accompanying drawings, in which embodiments of the invention are illustrated. Embodiments of the present invention are provided in order to more completely explain the present invention to one skilled in the art.

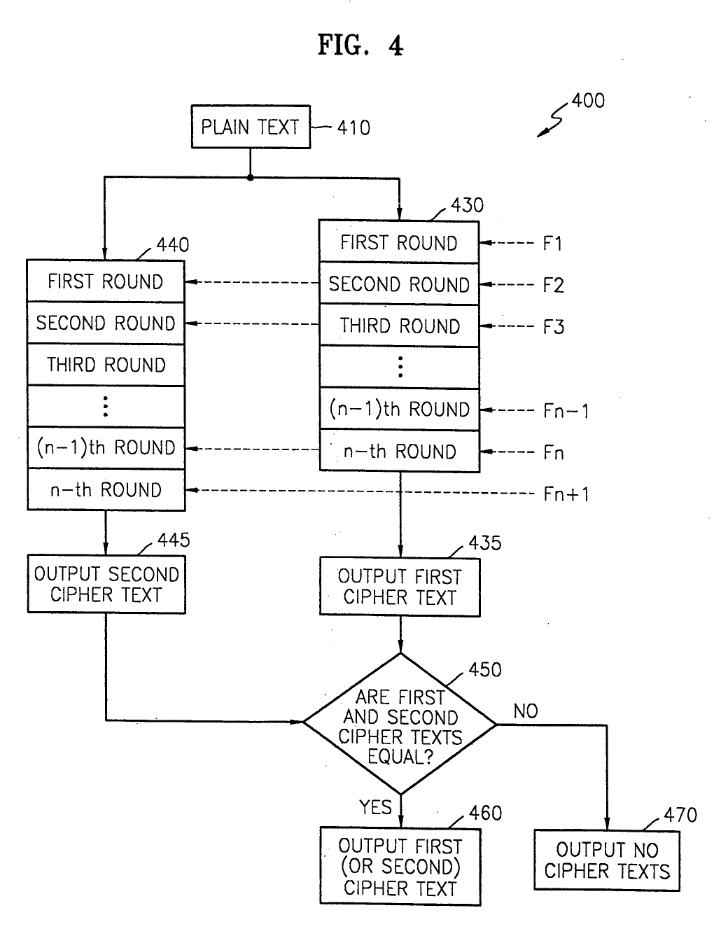

FIG. 4 is an exemplary illustration of a cryptographic engine implementing an overlapping operation, according to embodiments of the present invention. The cryptographic engine 400 may include the first hardware engine 430 and the second hardware engine 440, which use N overlapping operation modes. In the first hardware engine 430, fault sources F1, F2, F3, . . . , Fn−1, and Fn are provided to respective rounds. In the second hardware engine 440, fault sources F2, F3, . . . , Fn, and Fn+1 are provided to respective rounds. The fault sources F1, F2, F3, . . . , Fn−1, Fn, and Fn+1 can be environmental changes (e.g. temperature shock, barometric shock, radio frequency (RF) energy, heavy ion bombardment, ultraviolet, laser energy) which individually attack the rounds to generate faults in the rounds.

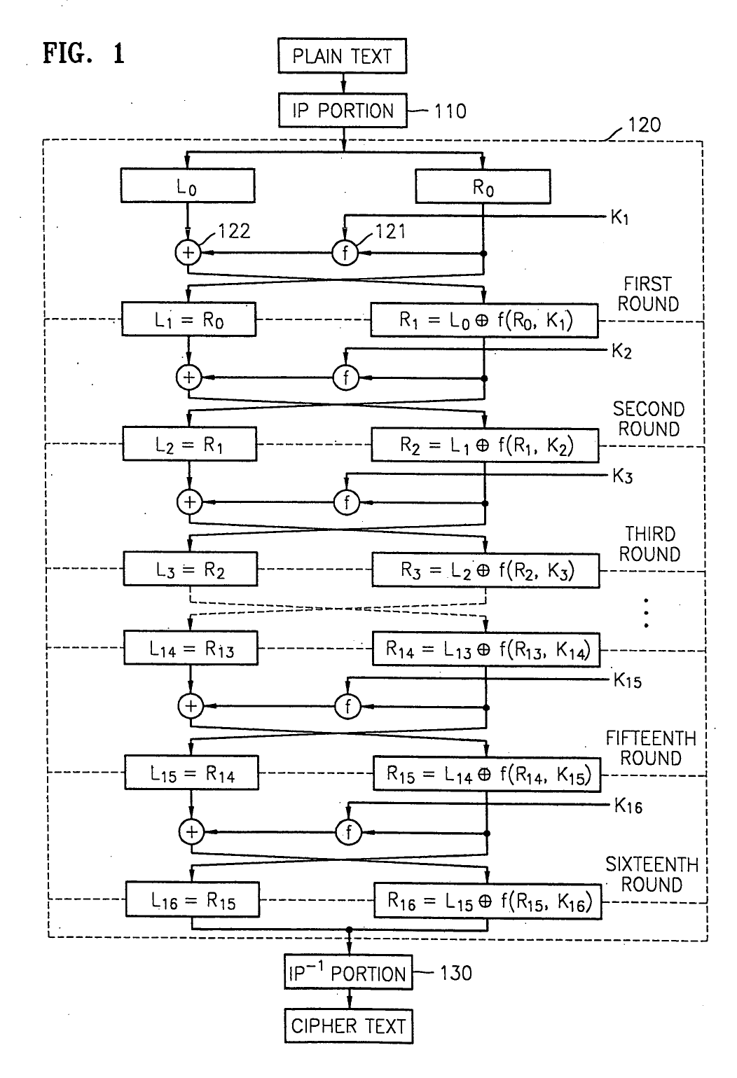

The 64-bit plain text block 410 is input to each of the first and second hardware engines 430 and 440. Each of the first and second hardware engines 430 and 440 has a similar structure to the transformation portion 120 of FIG. 1. Each of the first and second hardware engines 430 and 440 divide the 64-bit plain text block 410 into two 32-bit sub-blocks. Each of the first and second hardware engines 430 and 440 transfer one sub-block to the Lᵢ register of FIG. 1 and the other to the Rᵢ register of FIG. 1. Each of the first and second hardware engines 430 and 440 perform encryption on the data stored in the Rᵢ register and a subkey Kᵢ by using a cipher function (f). Each of the first and second hardware engines 430 and 440 perform an XOR operation on the result of the cipher function (f) and the output of the L register in an i-th round. Each of the first and second hardware engines 430 and 440 transfer the result of the XOR operation to an Rᵢ₊₁ register in an (i+1)th round and the data stored in the Rᵢ register to an Lᵢ₊₁ register in the (i+1)th round. This operation of one round repeats n times.

The first fault source F1 is present during a first round of the first hardware engine 430. The second through n-th fault sources F2, F3, . . . , Fn−1, and Fn are present during second through n-th rounds of the first hardware engine 430, respectively. The second fault source F2 received by the second round of the first hardware engine 430 is present during a first round of the second hardware engine 440. The third fault source F3 received by the third round of the first hardware engine 430 is present during a second round of the second hardware engine 440. The n-th fault source Fn received by the n-th round of the first hardware engine 430 is present during a (n−1)th round of the second hardware engine 440. The (n+1)th fault source is present during an n-th round of the second hardware engine 440. The 64-bit plain text block 410 is encrypted by the first hardware engine 430 and output as a first cipher text. The 64-bit plain text block 410 is also encrypted by the second hardware engine 440 and output as a second cipher text.

In the first round, the first hardware engine 430 receives the 64-bit plain text block 410 and outputs an operation effected by a first round fault generated due to the first fault source F1. In the second round, the first hardware engine 430 receives the operation result effected by the first round fault generated in the first round. The second round outputs an operation result based on the output of the first round and effected by a second round fault generated into the second fault source F2. Finally, in the n-th round, the first hardware engine 430 receives an operation result that is effected by an (n−1)th round fault generated in the (n−1)th round. In the n-th round, the first hardware engine 430 outputs the first cipher text effected by an n-th round fault generated due to the n-th fault source Fn, as shown in step 435.

In the first round, the second hardware engine 440 receives the 64-bit plain text block 410 and outputs an operation result effected by the second round fault generated due to the second fault source F2. In the second round, the second hardware engine 440 receives the operation result that is effected by the second round fault generated in the first round, and outputs an operation result that is effected by a third round fault generated due to the third fault source F3. In the (n−1)th round, the second hardware engine 440 receives an operation result that is effected by an (n−2)th round fault generated in the (n−2)th round, and outputs an operation result that is effected by the n-th round fault generated due to the n-th fault source Fn. In the n-th round, the second hardware engine 440 receives the operation result effected by the n-th round fault generated in the (n−1)th round, and outputs as the second cipher text an operation result effected by the (n+1)th round fault generated due to the (n+1)th fault source Fn+1, as shown in step 445.

In step 450, the first and second cipher texts are compared with each other. If the first and second cipher texts are identical, the identical cipher text is output, in step 460. If the first and second cipher texts are different, no cipher texts are output, in step 470. In the cryptographic engine 400, the first and second hardware engines 430 and 440 are expected to output first and second cipher texts that are identical, because the algorithms of first and second hardware engines 430 and 440 are the same. However, if corresponding rounds of the first and second hardware engines 430 and 440 are effected by different fault sources among F1, F2, . . . , F(n−1), Fn, and Fn+1, the output of first and second hardware engines 430 and 440 will be different. Accordingly, corresponding rounds of the first and second hardware engines 430 and 440 include different errors, thus increasing a probability that their operation results are different. Hence, if an encryption device is attacked by fault sources, the first and second cipher texts output by the first and second hardware engines 430 and 440, respectively, should be different. Likewise, if the first and second cipher texts output by the first and second hardware engines 430 and 440 are identical, this means that the 64-bit plain text block 410 has been successfully encrypted without being effected by the fault sources F1, F2, . . . , F(n−1), Fn, and Fn+1. In embodiments, different fault sources among F1, F2, . . . , F(n−1), Fn, and Fn+1 are provided to corresponding rounds of the first and second hardware engines 430 and 440. To achieve this, the first and second hardware engines 430 and 440 are offset in time by at least one round.

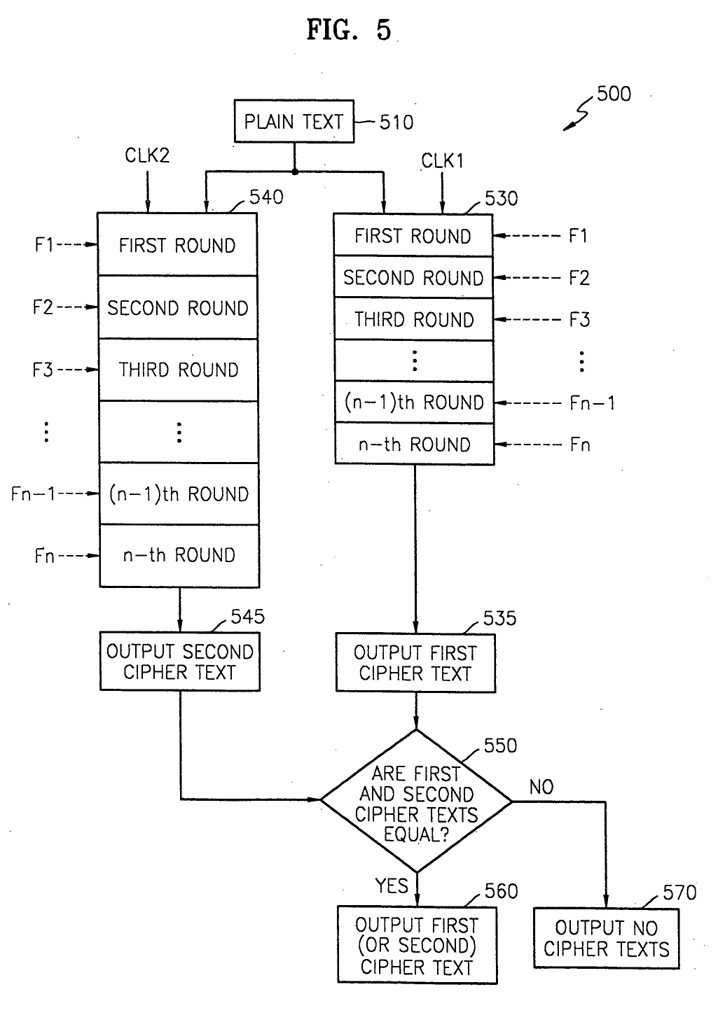

FIG. 5 illustrates an exemplary cryptographic engine 500 according to embodiments of the present invention utilizing a variable clock operation. The cryptographic engine 500 is different from the cryptographic engine 400 of FIG. 4 in that rounds of first and second hardware engines 530 and 540 are not offset in time. However, the frequency of a first clock signal CLK1 for first hardware engine 530 is set differently from that of a second clock signal CLK2 for second hardware engine 540.

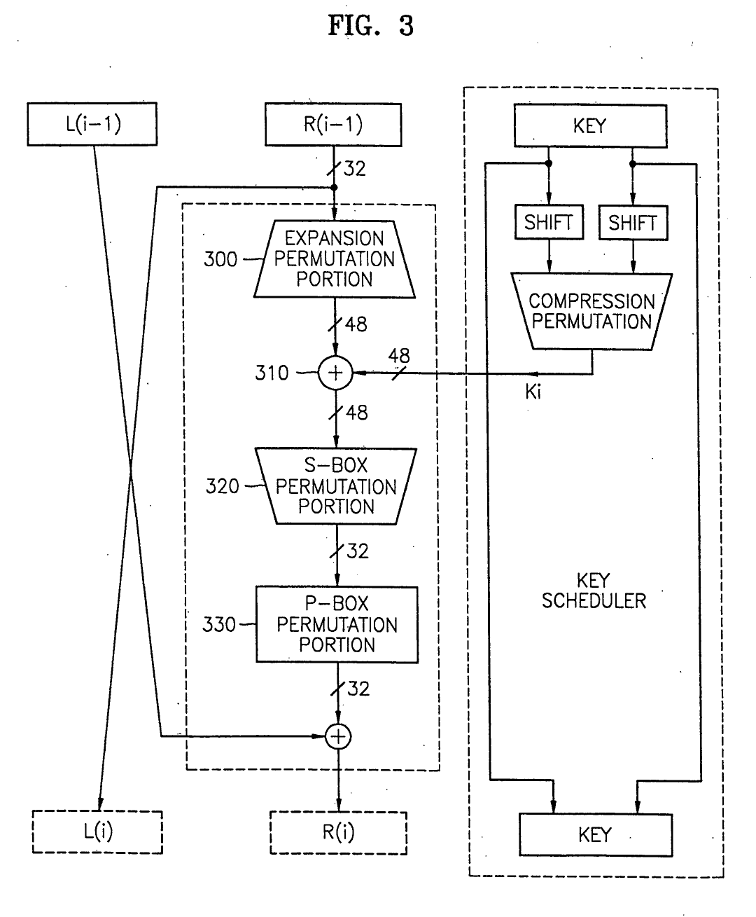

As an example, a 64-bit plain text block 510 is input to each of the first and second hardware engines 530 and 540. Each of the first and second hardware engines 530 and 540 divides the 64-bit plain text block 510 into two 32-bit sub-blocks. Each of the two 32-bit sub-blocks undergoes one round of the operation of FIG. 3. This round repeats n times. The first fault source F1 is provided to a first round of the first hardware engine 530. The second through n-th fault sources F2, F3, . . . , Fn−1, and Fn are provided to second through n-th rounds of the first hardware engine 530, respectively. The first fault source F1 provided to the first round of the first hardware engine 530 is also provided to a first round of the second hardware engine 540. The second fault source F2 provided to the second round of the first hardware engine 530 is also provided to a second round of the second hardware engine 540. The n-th fault source Fn provided to the n-th round of the first hardware engine 530 is also provided to an n-th round of the second hardware engine 540.

In the first round, the first hardware engine 530 receives the 64-bit plain text block 510 in response to the first clock signal CLK1 and outputs an operation result effected by a first round fault due to the first fault source F1. In the second round, the first hardware engine 530 receives the operation result effected by the first round fault in the first round and outputs an operation result effected by a second round fault due to the second fault source F2. In the n-th round, the first hardware engine 530 receives an operation result effected by an (n−1)th round fault generated in the (n−1)th round. The n-th round outputs first cipher text as an operation result effected by an n-th round fault generated due to the n-th fault source Fn, as shown in step 535.

In the first round, the second hardware engine 540 receives the 64-bit plain text block 510 in response to the second clock signal CLK2 and outputs an operation result effected by the first round fault due to the first fault source F1. In the second round, the second hardware engine 540 receives the operation result effected by the first round fault in the first round and outputs an operation result effected by a second round fault due to the second fault source F2. In the n-th round, the second hardware engine 540 receives the operation result effected by the (n−1)th round fault generated in the (n−1)th round and outputs as a second cipher text that is an operation result effected by an n-th round fault due to the n-th fault source Fn, as shown in step 545.

In step 550, the first and second cipher texts are compared with each other. If the first and second cipher texts are identical, the identical cipher text is output, in step 560. If the first and second cipher texts are different, no cipher texts are output, in step 570. In the cryptographic engine 500, the first and second hardware engines 530 and 540 are expected to output first and second cipher texts that are identical, because the algorithms of first and second hardware engines 530 and 540 are the same. However, the first and second hardware engines 530 and 540 start their operations at different points in time, because the first and second clock signals CLK1 and CLK2 have different clock frequencies. Accordingly, the first and second hardware engines 530 and 540 execute different rounds in the same time zone, and although an identical fault is provided at the same time, it effects different operation stages of the first and second hardware engines 530 and 540. Hence, the first and second hardware engines 530 and 540 output different operation results.

Nevertheless, if the first and second cipher texts output by the first and second hardware engines 530 and 540 are identical, this indicates that the 64-bit plain text block 510 has been stably encrypted with immunity against the fault sources F1, F2, . . . , F(n−1), Fn, and Fn+1. Thus, if the first and second cipher texts are identical, the cryptographic engine 500 outputs the first (or second) cipher text and finishes encryption.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method comprising:
encrypting first data with an encryption algorithm in a first circuit to output first encrypted data; and
encrypting the first data with the encryption algorithm in a second circuit to output second encrypted data;
comparing the first encrypted data and the second encrypted data at a third circuit; and
outputting the first encrypted data or the second encrypted data from the third circuit, only if the first encrypted data and the second encrypted data are the same.

2. The method of claim 1, wherein the encrypting in the first circuit is skewed in time with the encrypting in the second circuit.

3. The method of claim 2, wherein the encrypting in the first circuit is skewed in time with the encrypting in the second circuit so that fault sources inflicted on the first circuit and the second circuit effect the encryption algorithm differently so that only encrypted data that is unaffected by fault sources is output from the third circuit.

4. The method of claim 3, wherein the fault sources are at least one of:
environmental changes;
temperature shock;
barometric shock;
radio frequency energy;
heavy ion bombardment;
ultraviolet radiation; and
laser energy.

5. The method of claim 2, wherein the encrypting in the first circuit is skewed in time with the encrypting in the second circuit by the encrypting in the second circuit being delayed in time from the encrypting in the first circuit.

6. The method of claim 2, wherein the encrypting in the first circuit is skewed in time with the encrypting in the second circuit by the encrypting in the first circuit performed at a different frequency than the encrypting in the second circuit.

7. The method of claim 2, wherein the encrypting in the first circuit is skewed in time with the encrypting in the second circuit by:
the encrypting in the second circuit being delayed in time from the encrypting in the first circuit; and
the encrypting in the first circuit performed at a different frequency than the encrypting in the second circuit.

8. The method of claim 1, wherein:
the first data is a plain text block;
the first circuit is a first hardware engine; and
the second circuit is a second hardware engine;
the encryption algorithm comprises N rounds, wherein each of the N rounds of each of the first and second hardware engines comprises:
dividing the plain text box into two sub-blocks and storing one sub-block in a left register and the other in a right register;
executing an encryption operation by performing a cipher function with respect to data stored in the right register and a subkey; and
performing an exclusive OR operation on the result of the cipher function and the output of the left register, storing the result of the exclusive OR operation in a right register in the next round, and transferring data stored in the right register to a left register in the next round, wherein this round repeats N times and each of the first and second hardware engines performs first through N-th rounds of encryption algorithm.

9. The method of claim 8, wherein the two sub-blocks are 32 bits.

10. The method of claim 8, wherein the N rounds are 16 rounds.

11. The method of claim 1, wherein the encryption algorithm is a data encryption standard algorithm.

12. The method of claim 1, wherein the first data comprises 64 bits.

13. An apparatus comprising:
a first circuit which encrypts first data with an encryption algorithm to output first encrypted data; and
a second circuit which encrypts the first data with the encryption algorithm to output second encrypted data; and
a third circuit which:
compares the first encrypted data and the second encrypted data; and
outputs the first encrypted data or the second encrypted data from the third circuit, only if the first encrypted data and the second encrypted data are the same.

14. The apparatus of claim 13, wherein the encrypting in the first circuit is skewed in time with the encrypting in the second circuit.

15. The apparatus of claim 14, wherein the encrypting in the first circuit is skewed in time with the encrypting in the second circuit so that fault sources inflicted on the first circuit and the second circuit effect the encryption algorithm differently so that only encrypted data that is unaffected by fault sources is output from the third circuit.

16. The apparatus of claim 15, wherein the fault sources are at least one of:
environmental changes;
temperature shock;
barometric shock;
radio frequency energy;
heavy ion bombardment;
ultraviolet radiation; and
laser energy.

17. The apparatus of claim 14, wherein the encrypting in the first circuit is skewed in time with the encrypting in the second circuit by the encrypting in the second circuit being delayed in time from the encrypting in the first circuit.

18. The apparatus of claim 14, wherein the encrypting in the first circuit is skewed in time with the encrypting in the second circuit by the encrypting in the first circuit performed at a different frequency than the encrypting in the second circuit.

19. The apparatus of claim 14, wherein the encrypting in the first circuit is skewed in time with the encrypting in the second circuit by:
the encrypting in the second circuit being delayed in time from the encrypting in the first circuit; and
the encrypting in the first circuit performed at a different frequency than the encrypting in the second circuit.

20. The apparatus of claim 13, wherein the encryption algorithm is a data encryption standard algorithm.
